(19) United States
(12) Patent Application Publication
(10) Pub. No.: US 2019/0188063 A1
(43) Pub. Date: Jun. 20, 2019

(54) MAPPING COMPUTER PROGRAMS TO NETWORK PROTOCOL METHODS

(71) Applicant: SAP SE, Walldorf (DE)

(72) Inventors: Brian McKellar, Heidelberg (DE); Manuel Heibel, Walldorf (DE); Christopher Fries, Sandhausen (DE)

(21) Appl. No.: 15/845,449

(22) Filed: Dec. 18, 2017

(51) Int. Cl. G06F 9/54; G06F 3/048; H04L 29/08; H04L 9/06; G06F 17/30

(52) U.S. Cl. CPC G06F 9/548; G06F 3/048; G06F 17/30368; H04L 9/0637; G06F 17/301; H04L 67/1068

(57) ABSTRACT

A request to deploy a computer program is received. The computer program to be deployed on a computer system connected to a distributed peer-to-peer network. Computer systems in the network are referred to as nodes of a blockchain. The nodes are associated with corresponding databases storing copies of a distributed database record associated with the blockchain. Transactions executed over copies of the distributed database record are automatically replicated across the blockchain nodes. The deploy request includes metadata associated with the computer program. The metadata includes a property that associates a function of the computer program with a network protocol method. A mapping between the function of the program and the method is generated. When a request including the method is received, an invoke request including the function of the program and an endpoint, where the computer program is accessible, is automatically generated. The invoke request is sent to the endpoint.

### BACKGROUND

Application programming interfaces (APIs) describe ready-to-use functionalities that may be built into applications during development. An application programming interface (API) defines a way for a developer to write an application requesting functionalities from other applications or operating systems. A functionality may be provided by a function defined within a source code description of the API. In web development, application programming interfaces (APIs) are typically defined as sets of Hypertext Transfer Protocol (HTTP) request messages and definitions of response message structures in an Extensible Markup Language (XML) or JavaScript Object Notation (JSON) format. An API that utilizes HTTP requests to read, update, create, or delete (via HTTP methods GET, PUT, POST, DELETE, respectively) data is referred to as a representational state transfer (REST) API (i.e., RESTful API). Sending HTTP requests to communicate with RESTful APIs without having a documented description of functions defined within the corresponding RESTful API may be error-prone.

In distributed ledger technologies, when data are written on a computer system, the data are automatically replicated on a number of computer systems connected to the computer system in a peer-to-peer network. The data include collection of key-value pairs that represent assets in a binary and/or JSON form. Both tangible and intangible assets may be represented. The computer systems run software defining the assets and transaction instructions for modifying the assets. The software may be referred to as a smart contract. The smart contracts enforce rules for reading or altering the key-value pairs or other database information. Smart contract functions execute against the distributed ledger's current state database. Typically, smart contracts are accessed through invoke requests that include parameter values. The smart contracts blindly extract the parameter values from the invoke requests. Hence, accessing a smart contract through an HTTP request is further complicated because for an invoke request to be successful, sequence and type of the parameter values have to be correct.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating a system to analyze metadata, according to one embodiment.

FIG. 2 is a flow diagram illustrating a process to send a request to an endpoint, according to one embodiment.

FIG. 3 is a block diagram illustrating a system to generate a request, according to one embodiment.

FIGS. 4A-4B are flow diagrams illustrating a process to generate a request, according to one embodiment.

FIG. 5 illustrates an exemplary function and corresponding metadata, according to one embodiment.

FIG. 6 is a block diagram of an exemplary computer system, according to one embodiment.

### DETAILED DESCRIPTION

Embodiments of techniques for mapping computer programs to network protocol methods are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

RESTful APIs may be described in accordance with various known description formats and standards. For example, source code functions of a RESTful API may be described according to an API description format such as OpenAPI™. The OpenAPI™ description format provides a way to describe available endpoints (e.g., “/users”) and methods on an endpoint (e.g., “GET /users”, “POST /users”), function input and output parameters, authentication methods, contact information, license, terms of use, etc. API specifications may be written in various formats and markup languages including, but not limited to Yet Another Markup Language (YAML), RESTful API Modeling Language (RAML), and JSON. An API specification defines a variety of functions, how the functions may be called, and what functionality the functions provide. Additionally, the API specification may provide an overview of relationships between the functions and utilizing the provided functionality to leverage the API. The API specifications provide details for functional and expected behavior of APIs, as well as fundamental design philosophy and supported data types.

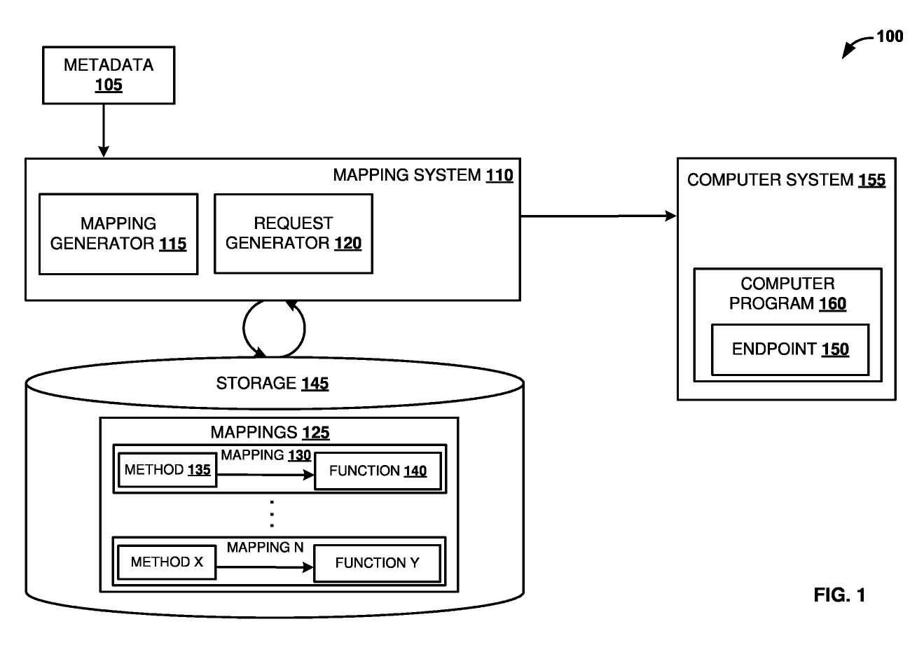

FIG. 1 illustrates a system 100 to analyze metadata 105, according to one embodiment. The metadata 105 is associated with a computer program 160 accessible at an endpoint 150 within computer system 155. The metadata 105 includes a specification of an API associated with the computer program 160. The endpoint 150 represents a uniform resource identifier (URI) within the computer system 155 where resources provided by the computer program 160 may be accessed. The computer program 160 may provide resources in the form of functionalities described by one or more functions within source code (not illustrated) of the computer program 160. The metadata 105 may be received at a mapping system such as mapping system 110.

In one embodiment, the mapping system 110 connects the computer system 155 to public networks such as the Internet and private networks such as an Intranet of an organization. The mapping system 110 receives requests, directed to the computer system 155. In one embodiment, the mapping system 110 manipulates the requests. For example, the mapping system 110 may convert a request received via a first network protocol (e.g., HTTP) into a request to be sent via a second network protocol (e.g., HTTP/2). As another example, the mapping system 110 may convert a RESTful API request into a remote procedure call (RPC). Alternatively, the mapping system 110 may forward the requests to the computer system 155 without amending the requests. The mapping system 110 exposes data, services, and computer programs from the computer system 155 to other networks. The mapping system 110 may be a separate unit that runs on a dedicated mapping system server (not illustrated). It should be appreciated that the mapping system 110 may also be realized as a software component rather than a hardware component and may run on a shared computer hardware together with one or more units of system 100. For example, the mapping system 110 and the computer system 155 may run on the same server.

In one embodiment, the mapping system 110 receives a request to deploy the computer program 160. The request may include the metadata 105 and source code (not illustrated) of the computer program 160. The metadata 105 include a specification of an API associated with the computer program 160. The API specification describes endpoints of functions of the computer program 160 (e.g., the endpoint 150) and input/output parameters for a function defined within the source code of the computer program 160. In addition, the metadata 105 describes an association between a function of the computer program 160 and an HTTP method. For example, the metadata 105 may include a property that is dedicated for mapping the HTTP method onto a corresponding function. The metadata 105 may be created in various languages or formats that support describing endpoints, parameters, and associations of source code functions with HTTP methods. For example, the metadata 105 may be written in a markup language such as YAML or RAML, or in a JSON format.

In one embodiment, source code of the computer program 160 is written in a high-level programming language. That is, the source code may not include descriptive information on how to interact with the computer program 160. In addition, functionality of the computer program 160 may be exposed via one or more APIs different from RESTful APIs. Therefore, the source code of the computer program 160 may be paired with the metadata 105 to provide a description of the computer program 160 to enable the mapping system 110 to expose the functionality of the computer program 160.

In one embodiment, the mapping system 110 includes a mapping generator 115 and a request generator 120. The mapping generator 115 is configured to parse the metadata 105. Based on the metadata 105, the mapping generator 115 determines a correspondence between a function of the computer program 160 and an HTTP method. For example, the mapping generator 115 may determine that the HTTP method “GET /URL” is associated with a function “read” of the computer program 160. The function is accessible at a corresponding endpoint (e.g., the endpoint 150). The computer program 160 may include one or more functions such as, for example, “read”, “write”, “update”, “delete”. The one or more functions may be accessible at one or more endpoints.

In one embodiment, the mapping generator 115 generates mappings 125. The mappings 125 are generated for the computer program 160 based on the metadata 105. The mappings 125 may include one or more mappings of HTTP methods to corresponding functions of the computer program 160. The mappings 125 include mapping 130. The mapping 130 maps method 135 to a corresponding function 140 in accordance with the metadata 105. For example, the method 135 may be a “PUT /URL” method associated with a “create” function 140 of the computer program 160 within the mapping 130. The “create” function 140 is available at a corresponding endpoint within the computer program 160.

In one embodiment, the mapping generator 115 stores the generated mappings 125 in storage 145. The storage 145 may be a database or a repository system connected to the mapping system 110. Although illustrated as an external unit to the mapping system 110, the storage 145 may also be an internal storage for the mapping system 110. For example, the storage 145 may be an in-memory database running on the same server as the mapping system 110. The storage 145 may include sets of mappings associated with a number of computer programs such as the computer program 160. The storage 145 may store mappings associated with computer programs that run on the computer system 155 or on other systems connected to the mapping system 110.

In one embodiment, the request generator 120 is configured to generate requests to the computer program 160. The requests may invoke one or more functions of the computer program 160. An invoke request to a function of the computer program 160 may include the function, one or more parameter values for one or more parameters of the function, and an endpoint within the computer program 160 where the function may be accessed.

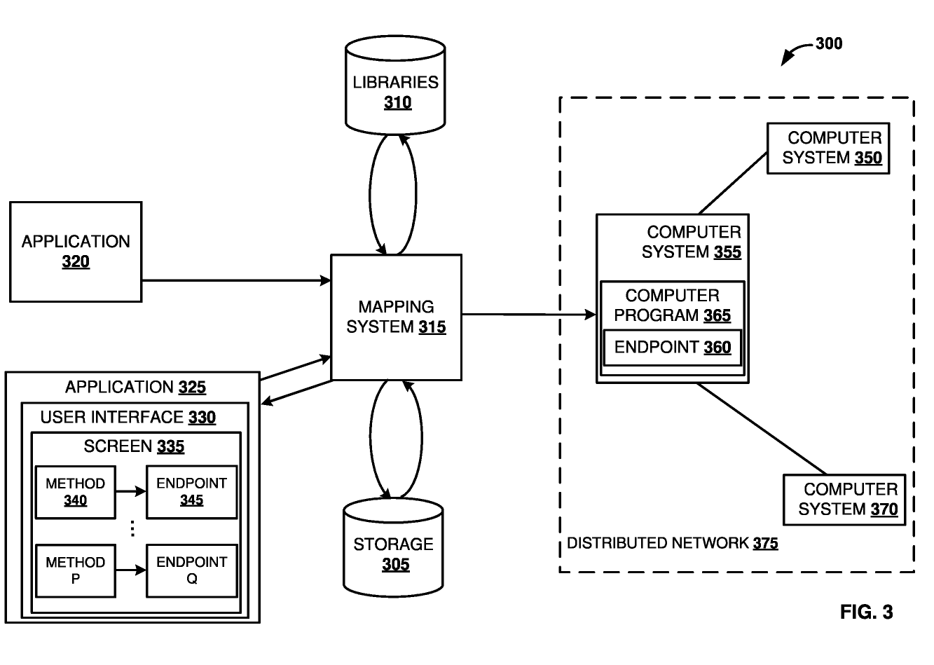

In one embodiment, the request generator 120 generates the request based on the mapping 130. For example, the request generator 120 may generate the invoke request in response to receiving, at the mapping system 110, a request to access the computer program 160. The generation of the request to invoke one or more functions will be described in detail below, with reference to FIG. 3.

In one embodiment, the computer program 160 is running on the computer system 155. The computer system 155 may be a personal computer, a server, a mobile device or another computing device that is capable of storing and executing computer readable instructions. The computer program 160 is associated with an endpoint 150 within the computer system 155. The endpoint 150 identifies a resource (e.g., a service or a function) within a network. One or more functions of the computer program 160 may be accessed at the endpoint 150.

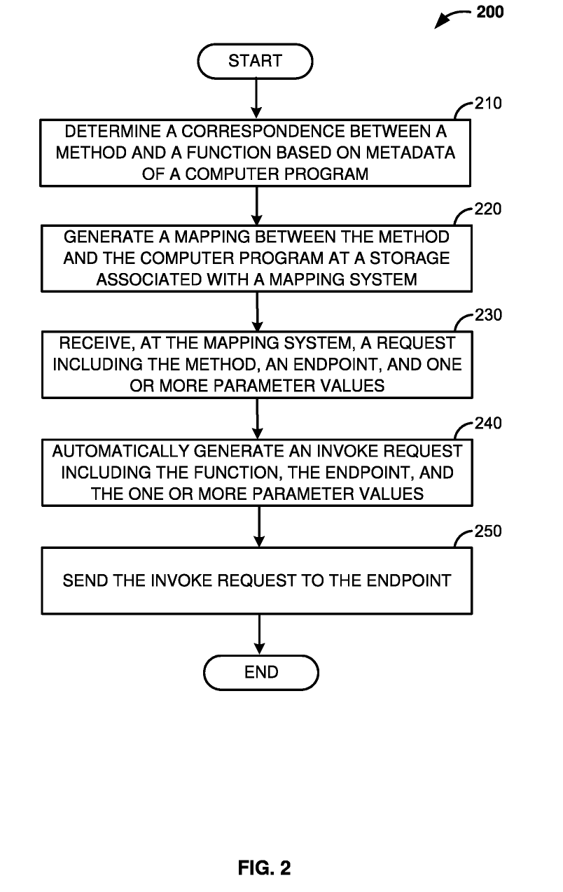

FIG. 2 illustrates a process 200 to send a request to an endpoint, according to one embodiment. The endpoint identifies a resource such as a service within a network. The service may be provided by a computer program running on a computer system connected to the network. The computer program may provide services based on one or more functions defined within the source code of the computer program. For example, the computer program may be similar to the computer program 160, FIG. 1.

At 210, a correspondence is determined between a method (e.g., an HTTP method) and a function of a computer program. The correspondence may be based on metadata of a computer program such as the computer program 160. The metadata may include a specification of an API associated with the computer program. The specification of the API includes available endpoints of functions of the computer program (e.g., the endpoint 150, FIG. 1), input and output parameters for the functions of the computer program, authentication methods, and so on. In addition, the specification of the API may include an association between a method and a function of the computer program. For example, a “PUT /URL” method may be associated with an “update” function of the computer program that is available at a corresponding endpoint. In one embodiment, the association in the API specification defines the correspondence between the method and the function of the computer program available at the endpoint.

At 220, a mapping is generated between the method and the corresponding function. The mapping is stored at a storage associated with a mapping system. The storage may include a number of mapping sets for a number of computer programs. For example, the mapping may be generated by the mapping generator 115, FIG. 1.

At 230, a request is received at the mapping system. The request includes the method, a URL, and one or more parameter values. For example, the request may be sent by a user or an application that requests access to one or more functions of the computer program.

At 240, an invoke request in automatically generated. The invoke request includes the function, the one or more parameter values, and the endpoint of the function corresponding to the method. The function is included in the invoke request based on the mapping between methods and functions that is stored at the storage. For example, the invoke request may be generated by the request generator 120, FIG. 1. At 250, the invoke request is sent to the endpoint.

FIG. 3 illustrates a system 300 to generate a request, according to one embodiment. The system 300 includes mapping system 315. The mapping system 315 is similar to the mapping system 110 described above with reference to FIG.1. The mapping system 315 receives requests directed to computer system 355. For example, the mapping system 315 may receive requests to deploy programs on the computer system 355 and/or to access services provided by the deployed programs.

In one embodiment, the mapping system 315 receives requests from application 320. The application 320 may be a UI application that receives user input commands and sends the deployment request in response to the commands. Alternatively, the application 320 may be an application configured to automatically send artifacts for deployment to the mapping system 315, e.g., on a predefined period of time or upon triggering of a predefined condition. One or more applications such as the application 320 may be connected to the mapping system 315.

In one embodiment, the application 320 requests deployment of a computer program on the computer system 355. For example, the application 320 may send a deployment request that includes artifacts (not illustrated) of computer program 365 to be deployed on the computer system 355. The artifacts include source code and metadata for the computer program. For example, the artifacts may include the metadata 105, FIG. 1. The metadata includes a specification of an API associated with the computer program 365. Based on the metadata, the mapping system 315 generates a number of mappings (such as the mappings 125, FIG. 1) for the computer program 365. The mappings associate an HTTP method with a function of the computer program 365. In one embodiment, the mapping system 315 is connected to storage 305. The mapping system 315 stores the mappings at the storage 305. The storage 305 is similar to the storage 145, FIG. 1. The storage 305 includes a number of mapping sets associated with a number of computer programs such as the computer program 365. The mapping sets are generated based on metadata of the number of computer programs.

In one embodiment, the mapping system 315 receives requests from application 325. The application 325 is an application that requests services provided by the computer program 365. The application 325 may consume a functionality provided by the computer program 365 or provide the functionality to a third party. For example, the application 325 may be configured to update data in a database by invoking the “update” function of the computer program 365. In one embodiment, the application 325 communicates with the mapping system 315 via RESTful API calls. One or more applications such as the application 325 may be connected to the mapping system 315.

In one embodiment, the application 325 sends to the mapping system 315 a request to access the computer program 365. The mapping system 315 is configured to generate and render a screen 335 to a user interface (UI) 330 of the application 325. The screen 335 includes one or more HTTP methods supported by the computer program 365 and corresponding one or more endpoints at the computer system 355 where the HTTP methods may be requested. For example, the screen 335 includes method 340 that is associated with a corresponding endpoint 345. Optionally, the screen 335 may include information for parameter sequence and names to be appended to a request including the method to the associated endpoint.

In one embodiment, the mapping system 315 generates the screen 335 based on the metadata of the computer program 365. As noted above, the metadata of the computer program 365 include a specification of an API associated with the computer program 365. The specification of the API includes available endpoints of functions of the computer program 365 (e.g., the endpoint 150, FIG. 1), input and output parameters for functions of the computer program, authentication methods, and so on. In addition, the specification of the API includes an association between an HTTP method and a function of the computer program 365.

In one embodiment, the mapping system 315 is in communication with libraries 310. The libraries 310 may include one or more of configuration data, documentation, pre-written source code and subroutines, classes, values, and type specifications. Based on the libraries 310 and the storage 305, the mapping system 315 automatically generates the screen 335. The mapping system 315 renders the screen 335 to the UI 330 that runs on the application 325. The UI 330 represents a client computer program that may be part of, or may be invoked from applications such as the application 325. Examples of client computer programs include, but are not limited to, web browsers, voice browsers, application clients, and other software that may access, consume and display content.

In one embodiment, the computer system 355 is part of a distributed network 375. The distributed network 375 may include a number of systems such as the computer system 355, computer system 350, and computer system 370. The distributed network 375 may be a peer-to-peer network. Computer systems in the distributed network 375 store a distributed database record. The distributed database record may include a sequenced, tamper-resistant record of transactions executed by the computer systems in the distributed network 375 and other data. The transactions may be executed over the sequenced record or over the data. Transactions represent state transitions performed when functions of computer programs such as the computer program 365 are invoked. When a transaction is executed at a computer system of the distributed network 375, the transaction is automatically replicated to copies of the sequenced record associated with the number of computer systems. A transaction creates a set of asset key-value pairs that are committed to the record as creates, updates, or deletes. Each computer system in the distributed network 375 maintains a copy of the record. For example, the computer systems 355, 350, and 370 may be referred to as nodes of a blockchain. A node of the blockchain is associated with a corresponding database (not illustrated) storing a copy of a distributed database record associated with the blockchain. Computer programs such as the computer program 365 may run on one or more of the blockchain nodes and may execute transactions over local copies of the distributed database record. The transactions may be automatically replicated across the blockchain nodes.

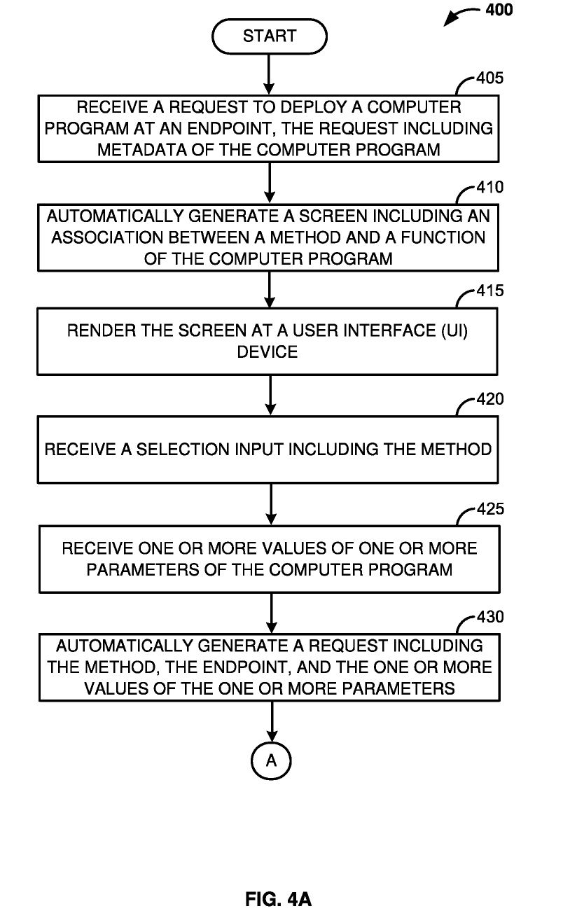

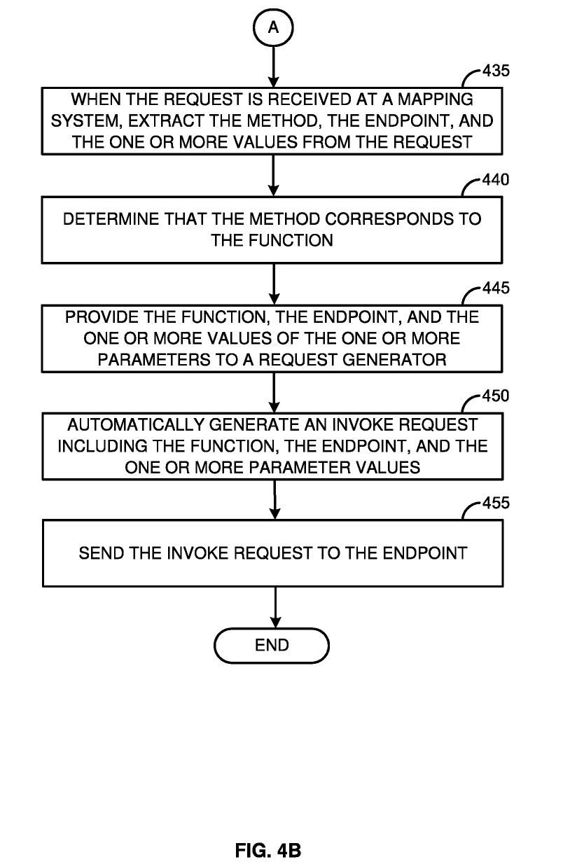

FIGS. 4A-4B illustrate a process 400 to generate an invoke request, according to one embodiment. At 405 (FIG. 4A), a request to deploy a computer program is received. For example, the request may be received at the mapping system 315, FIG. 3. The request includes source code and metadata of the computer program. At 410, a screen is automatically generated. The screen includes an association between an HTTP method and a function of the computer program. The screen is generated based on metadata of the computer program and one or more libraries available to the mapping system. At 415, the screen is rendered at a UI device.

At 420, a selection input including the method is received at the mapping system. The selection input may be provided by a user that views the screen. Alternatively, the input may be provided by an application configured to automatically provide input (e.g., based on predefined criteria) when the screen is rendered. In addition to the selection input, at 425, one or more values of one or more parameters of the computer program are received. At 430, a request to access the function is automatically generated. The request includes the method, the endpoint, and one or more values of the one or more parameters.

At 435 (FIG. 4B), when the request is received at a mapping system, the method, the endpoint, and the one or more parameter values are extracted from the request. At 440, the mapping system determines that the method corresponds to the function. At 445, the function, the endpoint, and the one or more parameter values are provided to a request generator of the mapping system. For example, the function, the endpoint, and the one or more parameter values are provided to the request generator 120, FIG. 1.

At 450, the request generator automatically generates an invoke request. The invoke request includes the function, the endpoint, and the one or more parameter values. At 455, the invoke request is sent to the endpoint.

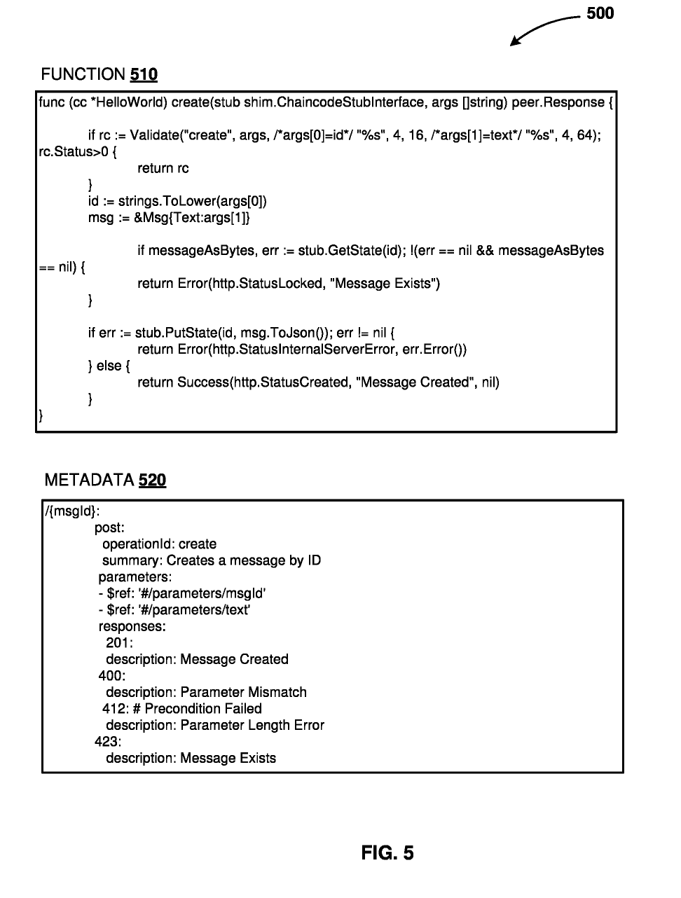

FIG. 5 illustrates an exemplary function 510 and corresponding metadata 520, according to one embodiment. For example, the exemplary function 510 is a “create” function of the compute program 160, FIG. 1. The function 510 creates a message with an identifier (ID) of the message. The function 510 validates and extracts parameters, validates whether a message with the ID already exists, and when a message with the ID does not exist, creates the message.

In one embodiment, the metadata 520 corresponds to the function 510. The metadata 520 defines an HTTP method “POST” as corresponding to the function 510 “create”. The metadata 520 represents an API specification of an API defined by source code of the function 510. The metadata 520 includes a summary of functionality provided by the function 510, specifies parameters of the function 510, and specifies HTTP response codes and corresponding labels for responses returned by the function 510. In addition, the metadata 520 includes a property “OperationID” that is mapped to the function 510 “create”. Based on the value of the property “OperationID”, the metadata 520 specifies correspondence between the HTTP method “POST” and the function 510 “create”.

Source code of a computer program may be written in a high-level programming language and may not include descriptive information on how to interact with the computer program. In addition, functionality of the computer program 160 may be exposed via one or more APIs that are different from RESTful APIs. Therefore, a system is described that maps an HTTP method to a function of a computer program. The mapping is generated based on metadata associated with the computer program. The metadata includes a specification of an API associated with the computer program. The API specification defines HTTP methods that correspond to functions of the computer program. An HTTP method is associated with a corresponding function of the computer program via an “OperationID” property in the metadata of the function. The system automatically translates, based on the generated mapping, requests that include HTTP methods into requests including functions of the computer program and sends the requests to the computer program. Pairing the source code of the computer program with the metadata provides a description of the computer program. Thus, a function of the computer program may be requested via a RESTful API call without having a documented description of functions defined within the corresponding RESTful API and the corresponding source code of the program.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java® programming language, C++, or other object-oriented programming language and development tools. Another embodiment may be implemented in hard-wired circuitry in place of, or in combination with machine readable software instructions.

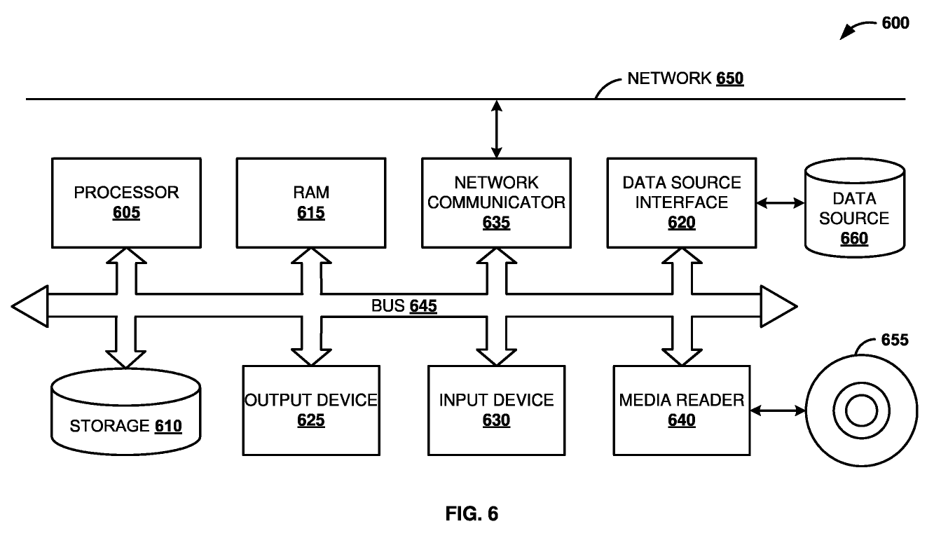

FIG. 6 is a block diagram of an exemplary computer system 600. The computer system 600 includes a processor 605 that executes software instructions or code stored on a computer readable storage medium 655 to perform the above-illustrated methods. The processor 605 may include a plurality of cores. The computer system 600 includes a media reader 640 to read the instructions from the computer readable storage medium 655 and store the instructions in storage 610 or in random access memory (RAM) 615. The storage 610 provides a large space for keeping static data where at least some instructions may be stored for later execution. According to some embodiments, such as some in-memory computing system embodiments, the RAM 615 may have sufficient storage capacity to store much of the data required for processing in the RAM 615 instead of in the storage 610. In some embodiments, all of the data required for processing may be stored in the RAM 615. The stored instructions may be further compiled to generate other representations of the instructions and dynamically stored in the RAM 615. The processor 605 reads instructions from the RAM 615 and performs actions as instructed. According to one embodiment, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output devices 625 and input devices 630 may be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 may be accessed via one or more abstraction layers implemented in hardware or software. For example, the data source 660 may be accessed by network 650. In some embodiments, the data source 660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources may include associated data foundations, semantic layers, management systems, security systems and so on.

In the above description, numerous specific details are set forth to provide a thorough understanding of embodiments. One skilled in the relevant art will recognize, however that the embodiments may be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications may be made in light of the above detailed description. Rather, the scope is to be determined by the following claims, which are to be interpreted in accordance with established doctrines of claim construction.

What is claimed is:

1. A computer implemented method comprising:
based on metadata of a computer program, determining a correspondence between a method of a network protocol and the computer program, wherein the computer program is accessible at an endpoint;
generating a mapping between the method and the computer program at a storage associated with a mapping system;
when a request comprising the method, the endpoint, and one or more values of one or more parameters is received at the mapping system, automatically generating an invoke request comprising the computer program, the endpoint, and the one or more values of the one or more parameters; and
sending the invoke request to the endpoint.

2. The method of claim 1, wherein determining the correspondence between the method and the computer program further comprises:
parsing the metadata; and
providing the method and the computer program to a mapping generator.

3. The method of claim 1 further comprising:
receiving a request to deploy the computer program, wherein the request comprises the metadata of the computer program.

4. The method of claim 3 further comprising:
based on the metadata and one or more libraries available to the mapping system, automatically generating a screen comprising an association between the method and the endpoint; and
rendering the screen at a user interface (UI) device connected to the mapping system.

5. The method of claim 4 further comprising:
receiving, from the UI device, a selection input comprising the method;
receiving the one or more values of the one or more parameters; and
automatically generating the request.

6. The method of claim 1, wherein automatically generating the invoke request further comprises:
extracting the method and the one or more values of the one or more parameters from the request;
determining, based on the mapping, that the computer program corresponds to the method; and
providing the computer program, the endpoint, and the one or more values of the one or more parameters to a request generator.

7. The method of claim 1, wherein the correspondence between the method and the computer program is configured by defining a property in the metadata of the computer program, wherein the property associates the computer program with the method.

8. A computer system to generate an invoke request, the system comprising:
a processor; and
a memory in association with the processor storing instructions related to:
based on metadata of a computer program, determining a correspondence between a method of a network protocol and the computer program, wherein the computer program is accessible at an endpoint;
generating a mapping between the method and the computer program at a storage associated with a mapping system;
when a request comprising the method, the endpoint, and one or more values of one or more parameters is received at the mapping system, automatically generating an invoke request comprising the computer program, the one or more values of the one or more parameters, and the endpoint; and
sending the invoke request to the endpoint.

9. The system of claim 8, wherein determining the correspondence between the method and the computer program further comprises:
parsing the metadata; and
providing the method and the computer program to a mapping generator.

10. The system of claim 9, wherein the instructions further comprising:
receiving a request to deploy the computer program at the endpoint, wherein the request comprises the metadata of the computer program.

11. The system of claim 10, wherein the instructions further comprising:
based on the metadata and one or more libraries available to the mapping system, automatically generating a screen comprising an association between the method and the computer program; and
rendering the screen at a user interface (UI) device connected to the mapping system.

12. The system of claim 11, wherein the instruction further comprising:
receiving, from the UI device, a selection input comprising the method;
receiving the one or more values of the one or more parameters; and
automatically generating the request.

13. The system of claim 8, wherein automatically generating the invoke request further comprises:
extracting the method and the one or more values of the one or more parameters from the request;
determining, based on the mapping, that the computer program corresponds to the method; and
providing the computer program, the endpoint, and the one or more values of the one or more parameters to a request generator.

14. The system of claim 8, wherein the correspondence between the method and the computer program is configured by defining a property in the metadata of the computer program, wherein the property associates the computer program with the method.

15. A non-transitory computer readable medium storing instructions which when executed by at least processor cause a computer system to perform operations comprising:
based on metadata of a computer program, determine a correspondence between a method of a network protocol and the computer program, wherein the computer program is accessible at an endpoint;
generate a mapping between the method and the computer program at a storage associated with a mapping system;
when a request comprising the method, the endpoint, and one or more values of one or more parameters is received at the mapping system, automatically generate an invoke request comprising the computer program, the one or more values of the one or more parameters, and the endpoint; and
send the invoke request to the endpoint.

16. The computer readable medium of claim 15, wherein the operations further comprising:
receive a request to deploy the computer program at the endpoint, wherein the request comprises the metadata of the computer program.

17. The computer readable medium of claim 16, wherein the operations further comprising:
based on the metadata and one or more libraries available to the mapping system, automatically generate a screen comprising an association between the method and the computer program; and
render the screen at a user interface (UI) device connected to the mapping system.

18. The computer readable medium of claim 17, wherein the operations further comprising:
receiving, from the UI device, a selection input comprising the method;
receiving the one or more values of the one or more parameters; and
automatically generating the request.

19. The computer readable medium of claim 15, wherein automatically generating the invoke request further comprises:
extract the method and the one or more values of the one or more parameters from the request;
determine, based on the mapping, that the computer program corresponds to the method; and
provide the computer program, the endpoint, and the one or more values of the one or more parameters to a request generator.

20. The computer readable medium of claim 15, wherein the correspondence between the method and the computer program is configured by defining a property in the metadata of the computer program, wherein the property associates the computer program with the method.
